(19) United States
(12) Patent Application Publication
(10) Pub. No.: US 2007/0119430 A1
(43) Pub. Date: May 31, 2007

(54) Intercooler

(75) Inventors: Haruhiko Watanabe, Chiryu-city (JP); Masaki Harada, Kariya-city (JP); Sumio Susa, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/595,137

(22) Filed: Nov. 9, 2006

(30) Foreign Application Priority Data
Nov. 29, 2005 (JP) 2005-342995

(51) Int. Cl. F02B 33/00

(52) U.S. Cl. 123/563

(57) ABSTRACT

An intercooler of an internal combustion engine comprises tubes 10 having an internal path of the intake air and inner fins 11 arranged in the tubes 10 in such a manner as to divide the flow path in each tube 10 into a plurality of thin flow paths 100 to promote the heat exchange between the intake air and the cooling fluid, wherein the inner fins 11 are straight fins with the walls 110 extending linearly in the direction of the intake air flow to divide the flow path into the thin flow paths 100 and the supercharged air flow rate is not less than 1200 kg/hr. The tubes 10 are formed of copper or a copper alloy having a plate thickness of 0.1 to 0.5 mm. Assuming that the interval between adjacent tubes 10 in the stacking direction is a tube pitch Tp and the height of the tubes 10 in the stacking direction is a tube height Th, the relation between the tube pitch Tp and the tube height Th is defined.

### BACKGROUND OF THE INVENTION

1. Field of the Invention

This invention relates to an intercooler for cooling the combustion air (intake air) taken into an internal combustion engine.

2. Description of the Related Art

In an internal combustion engine with a supercharger for large-sized trucks, the supercharged air pressure is set to about 180 kPa in many cases (the pressure in all cases described herein is the gauge pressure). The intercooler used under these conditions is generally formed of aluminum (See Japanese Unexamined Patent Publication No. 10-292996, for example).

The optimum design of this aluminum intercooler, taking the performance of the heat exchanger and the durability to the internal pressure into consideration, is known to be about 9 mm in tube height, about 0.5 mm in tube plate thickness and about 21 mm in tube pitch.

### SUMMARY OF THE INVENTION

In the internal combustion engine for large-sized trucks, the advisability of increasing the supercharged air pressure and the temperature is under study to meet the requirements, to restrict the emission of gas, which are expected more strict in the future. At the same time, the pressure resistance and the heat resistance of the intercooler must be considerably increased.

In such a case, the plate thickness is required to be considerably increased to secure the required strength of the conventional aluminum intercooler. An increased plate thickness, however, leads to a larger pressure loss, resulting in the deterioration of the performance of the heat exchanger. Therefore, the requirement must be met by changing the material.

The object of this invention is to determine the conditions for achieving a high performance of the intercooler and thereby improve the performance of the intercooler.

In order to achieve this object, according to a first aspect of this invention, there is provided an intercooler arranged downstream of a supercharger in the intake air flow for pressuring the intake air of an internal combustion engine to cool the intake air by exchanging heat between the intake air and a cooling fluid, comprising tubes (10) having an internal path of the intake air, and inner fins (11) arranged in the tubes (10) in such a manner as to divide the flow path in each tube (10) into a plurality of thin flow paths (100) to promote the heat exchange between the intake air and the cooling fluid, wherein each inner fin (11) is a straight fin with walls (110) dividing the thin flow paths (100) and extending linearly in the direction of the intake air flow, wherein the supercharged air flow rate is not less than 1200 kg/hr, wherein the tubes (10) are formed of copper or a copper alloy having a plate thickness of 0.1 to 0.5 mm, and wherein assuming that the interval between adjacent tubes (10) along the stacking direction is a tube pitch Tp, the height of the tube (10) along the stacking direction is a tube height Th, the tube pitch Tp is x (in mm) and the tube height Th is y (in mm), then the relation between x and y satisfies Equations 1 to 4.

As the result of a study by the present inventors, it has become apparent that the engine output Ps of an actual automotive vehicle is proportional to the supercharged air density ρ at the outlet of the intercooler. Thus, the present inventors studied the possibility of determining the optimum specification of the core of the intercooler from the relation between the supercharged air density ρ and the tube pitch Tp.

In the intercooler including the inner fins (11) as straight fins and the tubes (10) of copper or copper alloy as in the first aspect, a high-performance intercooler with the supercharged air density ρ of not lower than 98% of the maximum value can be obtained by setting the tube pitch Tp and the tube height Th to satisfy Equations 1 to 4. Thus, the optimum specification of the core of the intercooler can be determined with the tube pitch Tp and the tube height Th as parameters.

The study by the present inventors has also revealed that the supercharged air density ρ increases with the approach of the values x and y to the center of the area indicated by Equations 1 to 4. In the neighborhood of the boundary of the area expressed by Equations 1 to 4, therefore, the supercharged air density ρ is lower than in the neighborhood of the center of the area.

According to a second aspect of the invention, there is provided an intercooler wherein, assuming that the tube pitch Tp is x (in mm) and the tube height Th is y (in mm), the relation between x and y satisfies Equations 5 to 9.

As a result, a high-performance intercooler with the supercharged air density ρ of not lower than 98% of the maximum value can be obtained and, as compared with the first aspect, the difference of the supercharged air density ρ between the center and the boundary of the area is reduced.

According to a third aspect of the invention, there is provided an intercooler wherein, assuming that the tube pitch Tp is x (in mm) and the tube height Th is y (in mm), the relation between x and y satisfies Equations 10 to 12.

As a result, an intercooler very high in performance, with the supercharged air density ρ of not lower than 99% of the maximum value, can be obtained.

According to a fourth aspect of the invention, there is provided an intercooler wherein, assuming that the tube pitch Tp is x (in mm) and the tube height Th is y (in mm), the relation between x and y satisfies Equations 13 to 15.

As a result, an intercooler very high in performance, with the supercharged air density ρ of not less than 99% of the maximum value, can be obtained and, as compared with the third aspect, the difference of the supercharged air density ρ between the center and the boundary of the area can be further reduced.

In the first to fourth aspects described above, the tubes (10) can be formed of stainless steel or steel and can have the plate thickness of 0.07 to 0.5 mm.

According to a fifth aspect of the invention, there is provided an intercooler comprising inner fins (11) as straight fins, wherein de/(S/Swa) is 0.2 to 7.5, where S is the sectional area in one tube (10), Swa the total area of the thin flow paths (100) of one tube (10) and de (in mm) is the equivalent circle diameter of one thin flow path (100).

The equivalent circle diameter de herein is defined as 4×(Th−2×tt−ti)×(d/2−ti)/[2×((Th−2×tt−ti)+(d/2−ti))], where tt is the plate thickness of the tube (10) and ti the plate thickness of the inner fin (11).

The study by the present inventors confirmed that a high-performance intercooler can be obtained, as illustrated in FIG. 4, by setting de/(S/Swa) to 0.2 to 7.5.

Also, the inventors have confirmed that, by setting de/(S/Swa) to 0.3 to 4.5, an intercooler of a still higher performance can be obtained.

Further, the inventors have confirmed that, by setting de/(S/Swa) to 0.5 to 3.5, an intercooler very high in performance can be obtained.

In the first to fourth aspects described above, the inner fins (11) can be offset fins in each of which the walls (110) to form the thin flow paths (100) by division are arranged in staggered fashion along the direction of the intake air.

According to a sixth aspect of the invention, there is provided an intercooler comprising inner fins (11) as offset fins, wherein de/(S/Swa) is 0.4 to 9.5, where S is the sectional area in one tube (10), Swa the total area of the thin flow paths (100) of one tube (10) and de (in mm) the equivalent circle diameter of one thin flow path (100).

The study by the inventors confirmed that a high-performance intercooler can be obtained as illustrated in FIG. 5 by setting de/(S/Swa) to 0.4 to 9.5.

The inventors also confirmed that an intercooler of a higher performance can be obtained by setting de/(S/Swa) to 0.6 to 7.2.

The inventors further confirmed that an intercooler very high in performance can be obtained by setting de/(S/Swa) to 0.8 to 6.2.

The reference numerals in the parentheses attached to each means described above indicate the correspondence with specific means included in the embodiments described later.

The present invention may be more fully understood from the description of preferred embodiments of the invention, as set forth below, together with the accompanying drawings.

### BRIEF DESCRIPTION OF THE DRAWINGS

FIG. 1 is a front view of an intercooler according to an embodiment of the invention.

FIG. 2 is an enlarged view of portion A in FIG. 1.

FIG. 3 is a sectional view taken in line B-B in FIG. 2.

FIG. 4 is a diagram showing the result of calculation of the performance of a core 1 using the straight fins according to an embodiment of the invention.

FIG. 5 is a diagram showing the result of calculation of the performance of a core 1 using the offset fins according to an embodiment of the invention.

FIG. 6 is a characteristic diagram showing the relation between the plate thickness tt of the tube 10 and the stress exerted on the tube 10 according to an embodiment of the invention.

FIG. 7 is a characteristic diagram showing the relation between the plate thickness tt of the tube 10 and the weight of the core 1 according to an embodiment of the invention.

FIG. 8 is a diagram showing the result of calculation of the performance of the core 1 using the tube 10 formed of such a material as copper or stainless steel according to an embodiment of the invention.

FIG. 9 is a characteristic diagram showing the relation between the tube pitch Tp and the tube height Th with the supercharged air density ρ of not lower than 98% of the maximum value in FIG. 8.

FIG. 10 is a diagram showing an optimum area A defined by approximating the characteristic diagram of FIG. 9.

FIG. 11 is a diagram showing an optimum area B defined by approximating the characteristic diagram of FIG. 9.

FIG. 12 is a characteristic diagram showing the relation between the tube pitch Tp and the tube height Th with the supercharged air density ρ of not lower than 99% of the maximum value in FIG. 8.

FIG. 13 is a diagram showing an optimum area C defined by approximating the characteristic diagram of FIG. 12.

FIG. 14 is a diagram showing an optimum area D defined by approximating the characteristic diagram of FIG. 12.

### DESCRIPTION OF THE PREFERRED EMBODIMENTS

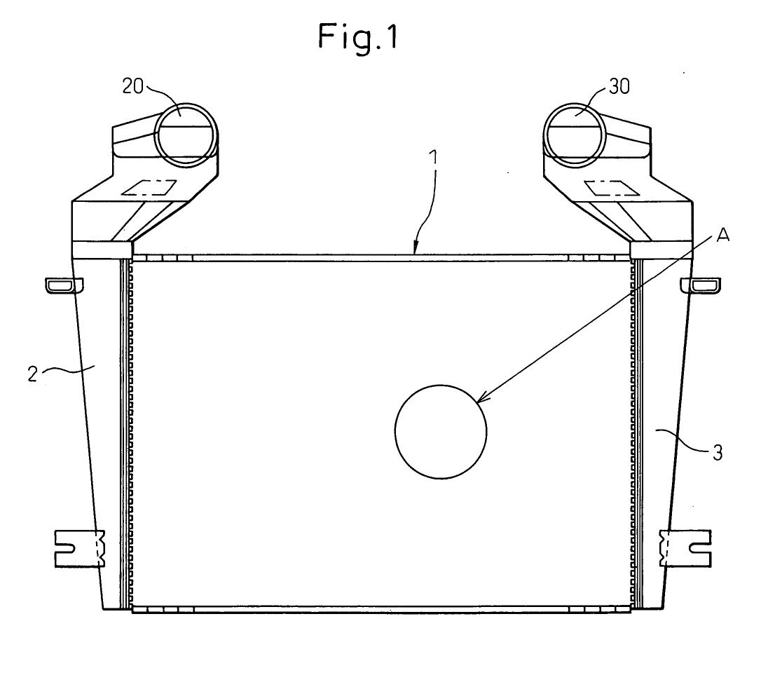

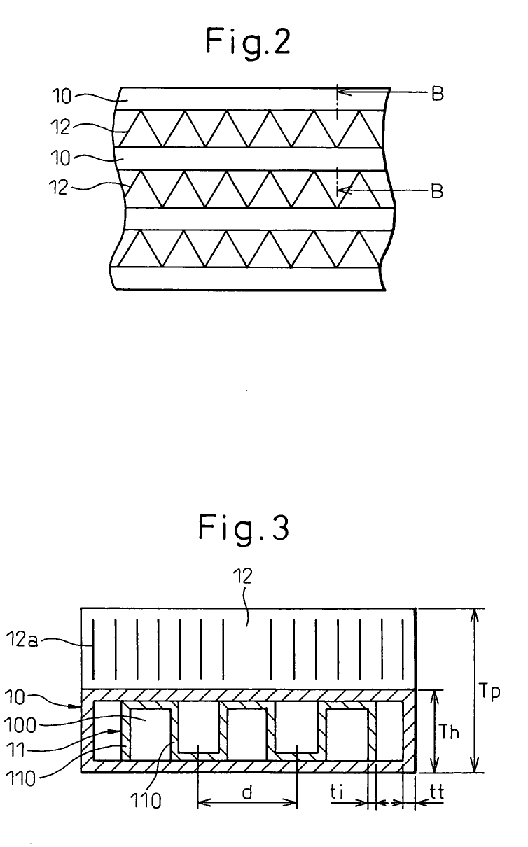

An embodiment of the invention is explained below. FIG. 1 is a front view of an intercooler according to an embodiment of the invention, FIG. 2 an enlarged view of the portion A in FIG. 1, and FIG. 3 a sectional view taken in line B-B in FIG. 2.

The intercooler according to this embodiment is arranged downstream of a supercharger (not shown), in the intake air flow, for compressing the intake air of an internal combustion engine (not shown) thereby to cool the intake air by heat exchange between the intake air and the cooling air. The cooling air corresponds to the cooling fluid according to the invention.

As shown in FIGS. 1 to 3, a core 1 of the intercooler includes a multiplicity of flat tubes 10 in a stack and having therein a flow path of the intake air, inner fins 11 arranged in the tubes 10 and outer fins 12 arranged between the stacked tubes 10.

The tubes 10 are formed of copper or stainless steel. The inner fins 11 and the outer fins 12 are formed of copper. In this specification, “copper” includes “a copper alloy”, and. “a stainless steel” includes “a steel”.

The outer fins 12 are corrugated and coupled to the tubes 10 to promote the heat exchange between the cooling air flowing between the tubes 10 and the intake air flowing in the tubes 10. The outer fins 12 are partly cut to form louvers 12a to disturb the air flow and prevent the growth of a thermal boundary layer.

The inner fins 11 are corrugated and coupled to the tubes 10 to promote heat exchange between the cooling air and the intake air. Also, the inner fins 11 have a multiplicity of walls 110 connecting the opposed surfaces of the tubes 10, whereby the flow path in the tubes 10 is divided into a plurality of thin flow paths 100. The inner fins 11 have no louvers.

Header tanks 2, 3 extending along the stacking direction of the tubes and communicating with the tubes 10 are arranged at the longitudinal ends of the tubes 10. The header tank 2 has the inlet 20 thereof connected with a supercharger for distributing the intake air supplied from the supercharger under pressure to the tubes 10. The other header tank 3 has the outlet 30 thereof connected to the intake port of the internal combustion engine so that the intake air flowing out of the tubes 10 is collected and sent out to the intake port of the internal combustion engine. The header tanks 2, 3 are both formed of copper.

The optimum range of the plate thickness ti (in mm: see FIG. 3) of the inner fins 11 of the intercooler according to this embodiment having the above-mentioned configuration was studied.

This study was conducted under the conditions described below. First, the specification of the intercooler is such that the inner fins 11 are straight fins having the walls 110 linearly extending along the direction of the intake air flow in the tubes 10.

The core 1 is 596.9 mm wide, 886 mm tall and 56 mm thick. The width of the core 1 is the size taken laterally on the page of FIG. 1, the height of the core 1 the size taken vertically on the page of FIG. 1, and the thickness of the core 1 the size taken in the direction perpendicular to the page of FIG. 1.

Each tube 10 has a height Th of 5.9 mm (FIG. 3) and a thickness of 56 mm and the plate thickness tt (FIG. 3) of 0.3 mm. The tube height Th is the size taken vertically on the page of FIG. 1, and the thickness of the tube 10 is the size taken in the direction perpendicular to the page of FIG. 1. The outer fins 12 have a fin pitch of 4.0 mm and a plate thickness of 0.05 mm.

The performance of the core 1 is calculated under the conditions described below. Specifically, the temperature of the cooling air flowing into the intercooler is 30° C., the velocity of the cooling air is 8 m/s, the temperature of the supercharged air (intake air) at the inlet 20 of the header tank 2 is 180° C., the pressure of the supercharged air at the inlet 20 of the header tank 2 is 200 kPa, and the mass flow rate of the supercharged air is 2,000 kg/hr.

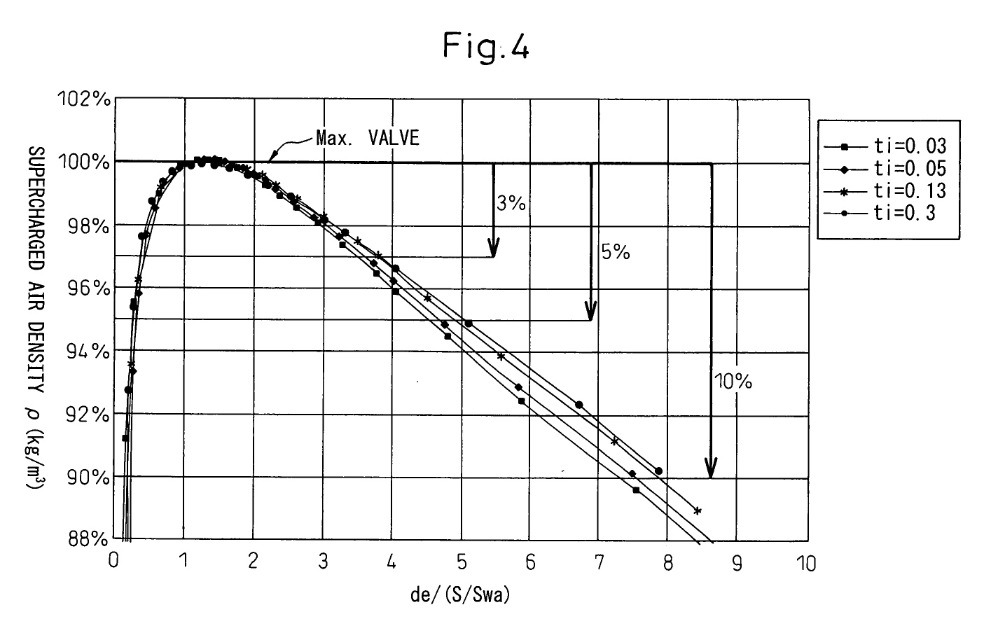

FIG. 4 shows the result of calculation of the performance of the core 1. The ordinate represents the density ρ of the supercharged air after it has passed through the intercooler, and the abscissa the corrected equivalent circle diameter as conceived and employed by the inventors. This corrected equivalent circle diameter is given as de/(S/Swa), where S is the sectional area perpendicular to the direction of intake air flow in one tube 10, Swa the total flow path area of the thin flow paths 100 in one tube 10 and de (in mm) the equivalent circle diameter of one thin flow path 100.

As apparent from FIG. 4, in the intercooler having the inner fins 11 as straight fins and the supercharged air pressure not lower than 200 kPa or the inner fins 11 as straight fins with both the tubes 10 and the inner fins 11 formed of copper, the supercharged air density p is increased to not lower than 90% of the maximum value by setting the corrected equivalent circle diameter to 0.2 to 7.5, not lower than 95% of the maximum value by setting the corrected equivalent circle diameter to 0.3 to 4.5, and not lower than 97% of the maximum value by setting the corrected equivalent circle diameter to 0.5 to 3.5.

Next, the inventors studied the optimum specification of the core 1 using offset fins as the inner fins 11. Offset fins, as is well known, are such that the walls 110 are arranged in staggered fashion along the direction of intake air flow in the tubes 10. The remaining conditions are identical to those for the aforementioned case.

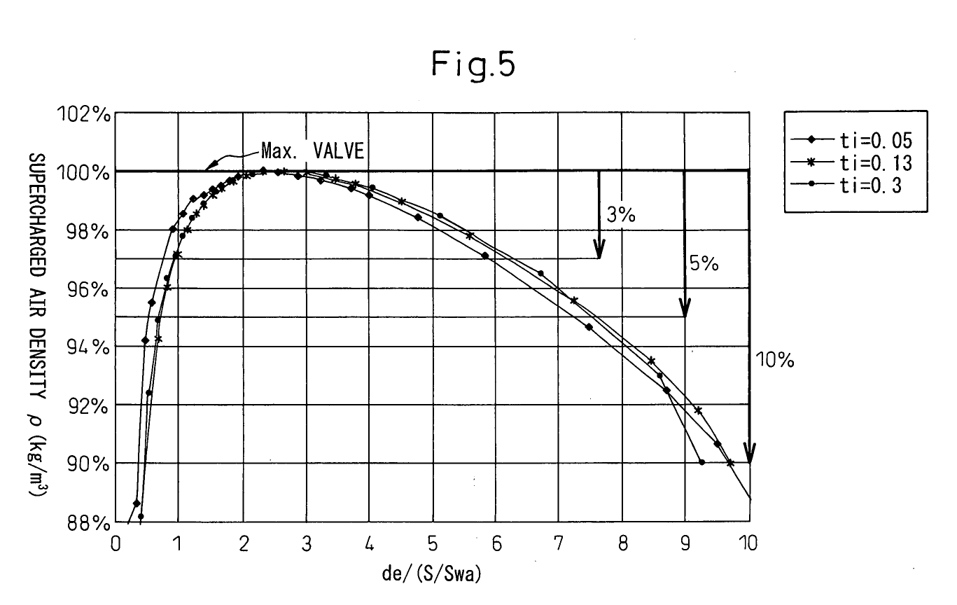

FIG. 5 shows the calculation result. In the intercooler in which the inner fins 11 are offset fins and the supercharged air pressure is not lower than 200 kPa or the inner fins 11 are offset fins and both the tubes 10 and the inner fins 11 are formed of copper, the supercharged air density ρ is increased to not lower than 90% of the maximum value by setting the corrected equivalent circle diameter to 0.4 to 9.5, not lower than 95% of the maximum value by setting the corrected equivalent circle diameter to 0.6 to 7.2, and not lower than 97% of the maximum value by setting the corrected equivalent circle diameter to 0.8 to 6.2.

The optimum range of the plate thickness tt (in mm: FIG. 3) of the tubes 10 of the intercooler according to this embodiment was also studied.

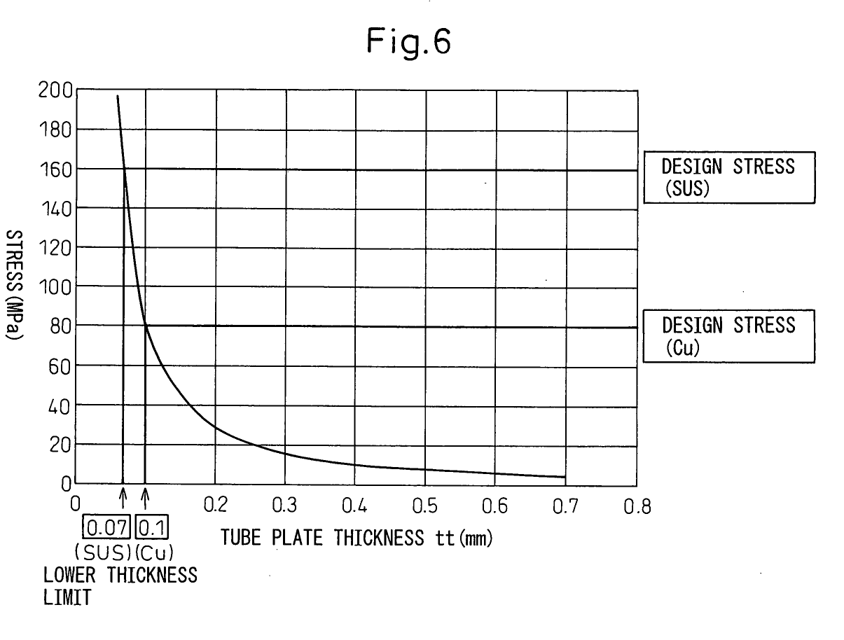

FIG. 6 is a characteristic diagram showing the relation between the plate thickness tt of the tube 10 and the stress exerted on the tube 10 under the internal pressure of 200 kPa. The ordinate represents the stress exerted on the tube 10, and the abscissa the plate thickness tt of the tube 10. The tube height Th is 6.5 mm, and the tube pitch Tp is 17.5 mm.

The design stress of copper and stainless steel, as calculated from the fatigue limit, are 80 MPa for copper and 160 MPa for stainless steel. As shown in FIG. 6, therefore, the lower limit of the plate thickness tt of the tube 10 is 0.1 mm for copper and 0.07 mm for stainless steel.

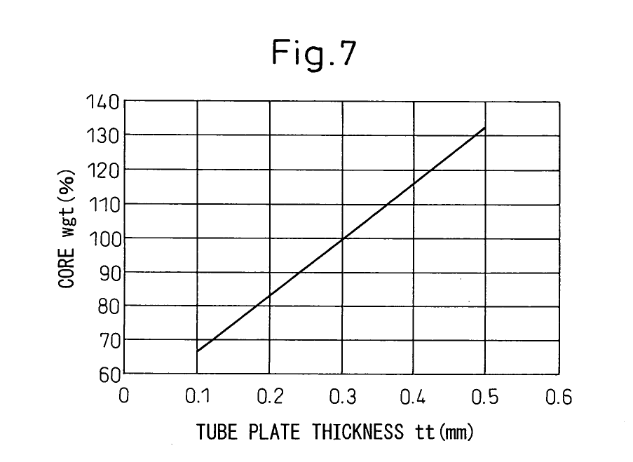

FIG. 7 is a characteristic diagram showing the relation between the plate thickness tt of the tube 10 and the weight of the core 1. The ordinate represents the core weight percent assuming that the core weight is 100% in the case where the plate thickness tt of the tube 10 is 0.3 mm, and the abscissa the plate thickness tt of the tube 10. The tube height Th is 6.5 mm, and the tube pitch Tp is 17.5 mm.

As shown in FIG. 7, the core weight increases with the plate thickness tt of the tube 10, thereby deteriorating the vibration resistance and the mountability and increasing the materials cost. From the practical point of view, therefore, the limit of the plate thickness tt of the tube 10 is 0.5 mm for both copper and stainless steel.

Therefore, the optimum plate thickness tt of the copper tube 10 is 0.1 to 0.5 mm, and that of the stainless steel tube 10 is 0.07 to 0.5 mm.

The use of copper or stainless steel for the tube 10 as in this embodiment can improve the strength at high temperature while at the same time reducing the plate thickness tt.

With regard to the intercooler according to this embodiment having the aforementioned configuration, the optimum specification of the core 1 was studied by calculating the performance of the core 1 while changing the plate thickness tt of the tube 10.

This study was conducted under the following conditions. First, the specification of the intercooler is such that the core 1 is 588.5 mm wide, 886 mm tall and 66 mm thick.

The tubes 10 each have a height Th of 6.5 mm, a length of 66 mm and a plate thickness tt of 0.3 mm. The outer fins 12 have a fin pitch of 4.0 mm and a plate thickness of 0.05 mm.

The performance of the core 1 was calculated under the following conditions. Specifically, the temperature of the cooling air flowing into the intercooler is 25° C., the velocity of the cooling air is 4 m/s, the temperature of the supercharged air (intake air) at the inlet 20 of the header tank 2 is 300° C., the pressure of the supercharged air at the inlet 20 of the header tank 2 is 400 kPa, and the mass flow rate of the supercharged air is 2700 kg/hr.

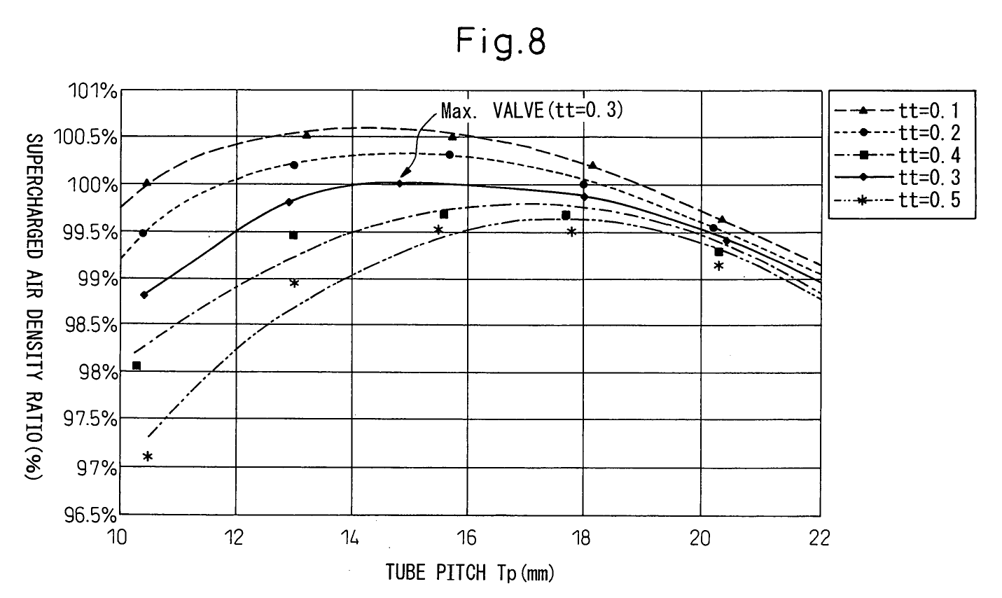

FIG. 8 shows the result of performance calculation of the core 1. The ordinate represents the density ρ of the supercharged air passed through the intercooler, and the abscissa the tube pitch Tp.

From FIG. 8, the tube pitch Tp, associated with the supercharged air density ρ not lower than 98% of the maximum value (tt=0.3), is calculated. From the tube pitch Tp thus calculated, the tube height Th is determined by calculation.

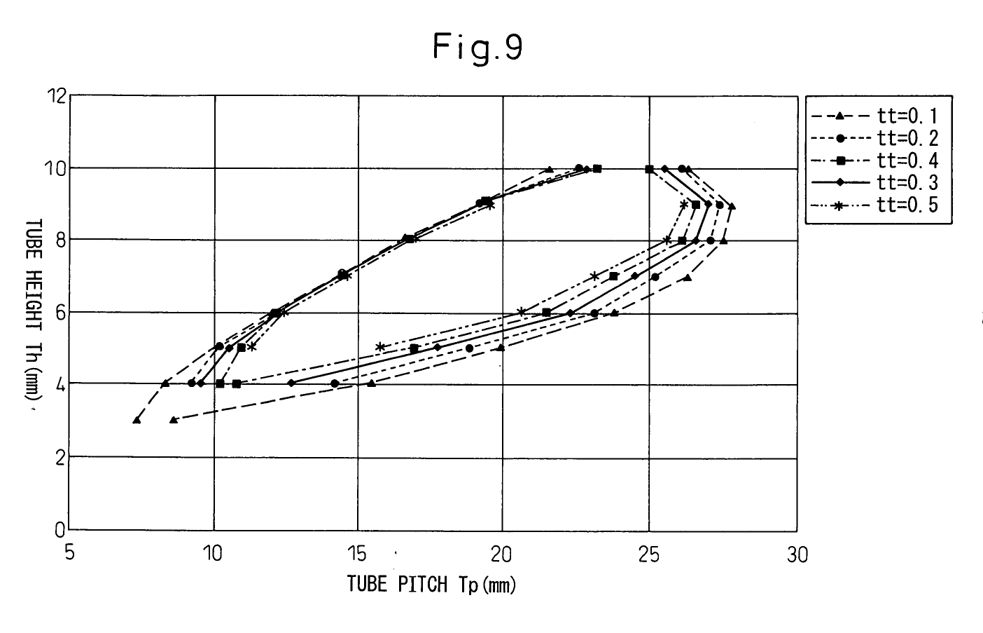

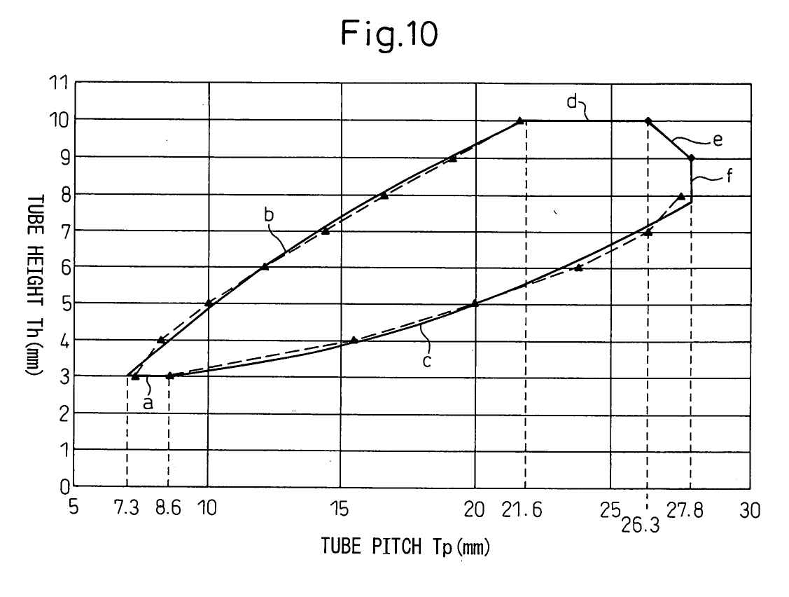

FIG. 9 shows the calculation result, and FIG. 10 the result of approximating and expressing in numerical formulae the data shown in FIG. 9. Specifically, in FIG. 10, the tube pitch Tp is assumed to be x (mm), the tube height Th to be y (mm), and the solid lines a to f to be the following Equations 16 to 21, respectively.
y=3 (Equation 16)
y=−0.0108x²+0.778x−1.86 (Equation 17)
y=0.0107x²−0.138x+3.45 (Equation 18)
y=10 (Equation 19)
y=−0.667x+27.5 (Equation 20)
x=27.8 (Equation 21)

The tube pitch Tp and the tube height Th are determined in such a manner as to be included in the area (hereinafter referred to as the optimum area A) defined by the six equations described above. Specifically, the relation between x and y is set to satisfy the following four equations.
3≦y≦−0.0108x²+0.778x−1.86(7.3≦x≦8.6) (Equation 1)
0.0107x²−0.138x+3.45≦y≦−0.0108x²+0.778x−1.86(8.6≦x≦21.6) (Equation 2)
0.0107x²−0.138x+3.45≦y≦10 (21.6≦x≦26.3) (Equation 3)
0.0107x²−0.138x+3.45≦y≦−0.667x+27.5(26.3≦x≦27.8) (Equation 4)
In this way, a high-performance intercooler can be obtained in which the supercharged air density ρ is not lower than 98% of the maximum value (tt of 0.3). Thus, the optimum specification of the core 1 can be determined with the tube pitch Tp and the tube height Th as parameters.

The study by the present inventors made it clear that the supercharged air density ρ increases with the approach of the x and y values to the center of the optimum area. In the neighborhood of the boundary of the optimum area, therefore, the supercharged air density ρ is lower than in the neighborhood of the central area.

In view of this, the inventors studied a new optimum area where the difference in supercharged air density ρ between the boundary and the center of the area is smaller in the case where the tube pitch Tp and the tube height Th constitute parameters.

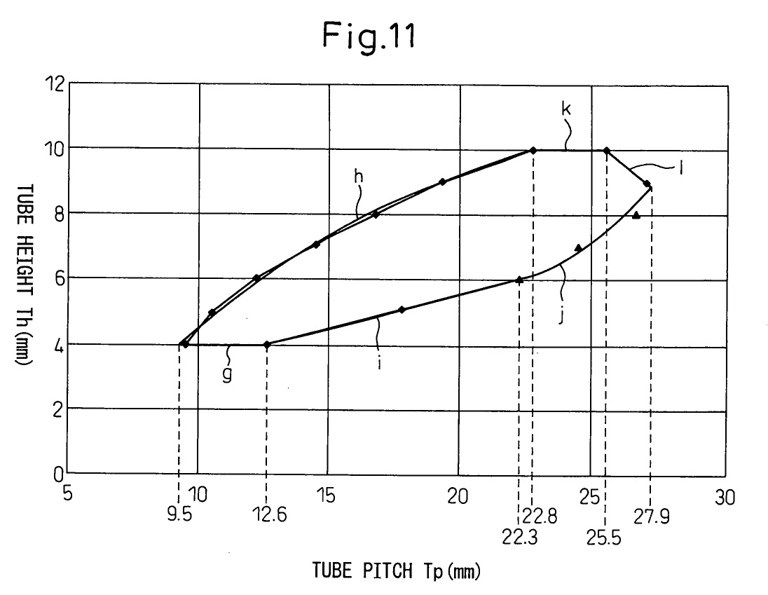

FIG. 11 shows the result of the study, in which the solid lines g to l represent Equations 22 to 27 shown below.
y=4 (Equation 22)
y=−0.0165x²+0.966x−3.49 (Equation 23)
y=−0.00120x²+0.250x+1.00 (Equation 24)
y=0.0732x²−3.04x+37.4 (Equation 25)
y=10 (Equation 26)
y=−0.667x+27.0 (Equation 27)

The tube pitch Tp and the tube height Th are determined in such a manner as to be included in the area (hereinafter referred to as the optimum area B) defined by the six equations described above. Specifically, the relation between x and y is set to satisfy the five equations below.
4≦y≦−0.0165x²+0.966x−3.49(9.5≦x≦12.6) (Equation 5)
−0.00120x²+0.250x+1.00≦y≦−0.0165x²+0.966x−3.49(12.6≦x≦22.3) (Equation 6)
0.0732x²−3.04x+37.4≦y≦−0.0165x²+0.966x−3.49(22.3≦x≦22.8) (Equation 7)
0.0732x²−3.04x+37.4≦y≦10(22.8≦x≦25.5) (Equation 8)
0.0732x²−3.04x+37.4≦y≦−0.667x+27.0(25.5≦x≦27.9) (Equation 9)
In this way, a high-performance intercooler can be obtained in which the supercharged air density ρ is not lower than 98% of the maximum value (for a tt of 0.3). Further, as the optimum area B is smaller than the optimum area A, the difference of the supercharged air density ρ between the center and boundary of the area can be reduced more.

Returning to FIG. 8, the tube pitch Tp is calculated at which the supercharged air density ρ is not lower than 99% of the maximum value (for tt of 0.3). From the tube pitch Tp thus calculated, the tube height Th is determined by calculation.

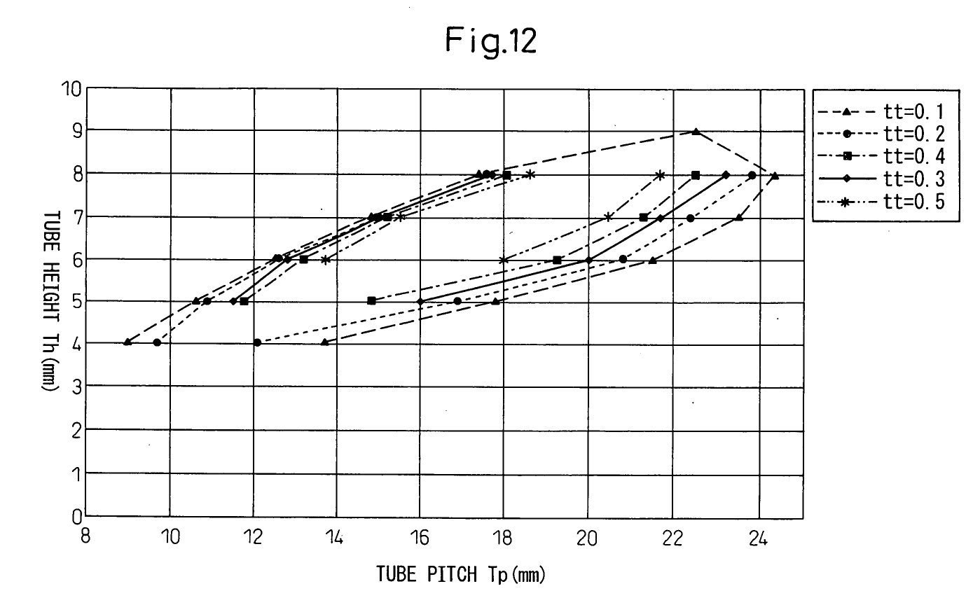

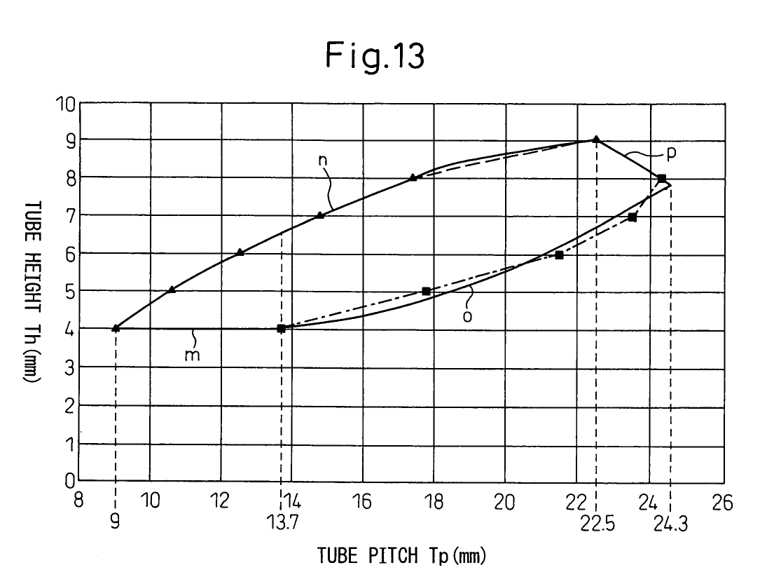

FIG. 12 shows the calculation result. FIG. 13 shows the result of approximating and expressing in numerical formulae the data of FIG. 12. Specifically, in FIG. 13, the tube pitch Tp is assumed to be x (mm), the tube height Th to be y (mm), and the solid lines m to p the following Equations 28 to 31, respectively.
y=4 (Equation 28)
y=−0.0198x²+0.995x−3.34 (Equation 29)
y=0.0265x²−0.660x+8.15 (Equation 30)
y=−0.556x+21.5 (Equation 31)

The tube pitch Tp and the tube height Th are determined in such a manner as to be included in the area (hereinafter referred to as the optimum area C) defined by the four equations described above. Specifically, the relation between x and y is set to satisfy the following three equations.
4≦y≦−0.0198x²+0.995x−3.34(9≦x≦13.7) (Equation 10)
0.0265x²−0.660x+8.15≦y≦−0.0198x²+0.995x−3.34(13.7≦x<22.5) (Equation 11)
0.0265x²−0.660x+8.15≦y≦−0.556x+21.5(22.5≦x≦24.3) (Equation 12)
In this way, an intercooler very high in performance can be obtained in which the supercharged air density ρ is not lower than 99% of the maximum value (for a tt of 0.3).

Also, in the same way that the optimum area B is determined, the present inventors studied a new optimum area where the difference in the supercharged air density p between the boundary and center of the area decreases in the case where the tube pitch Tp and the tube height Th constitute parameters.

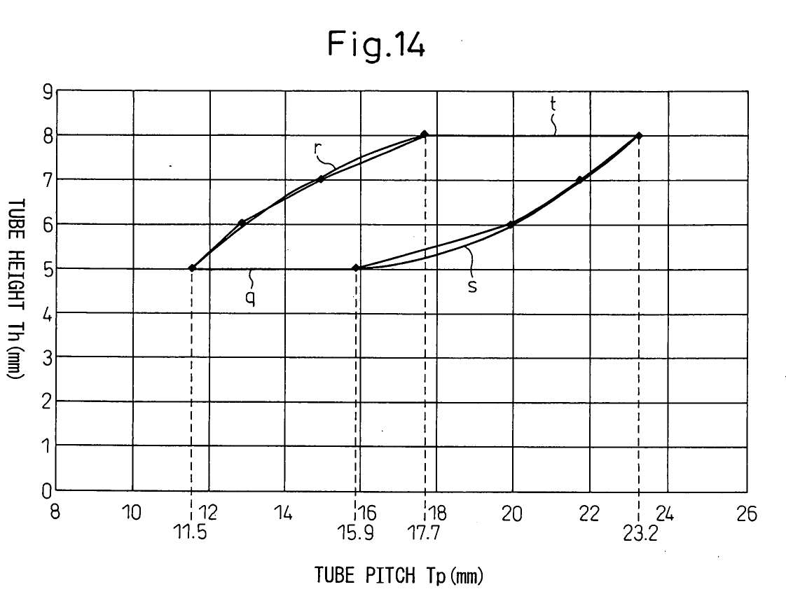

FIG. 14 shows the result of the study in which the solid lines q to t indicate Equations 32 to 35.
y=5 (Equation 32)
y=−0.0380x²+1.58x−8.13 (Equation 33)
y=0.0507x²−1.57x+17.1 (Equation 34)
y=8 (Equation 35)

The tube pitch Tp and the tube height Th are determined in such a manner as to be included in the area (hereinafter referred to as the optimum area D) defined by the four equations described above. Specifically, the relation between x and y is set to satisfy the following three equations.
5≦y≦−0.0380x²+1.58x−8.13(11.5≦x≦15.9) (Equation 13)
0.0507x²−1.57x+17.1≦y≦−0.0380x²+1.58x−8.13(15.9≦x≦17.7) (Equation 14)
0.0507x²−1.57x+17.1≦y≦8(17.7≦x≦23.2) (Equation 15)
In this way, an intercooler very high in performance can be obtained in which the supercharged air density ρ is not lower than 99% of the maximum value (for a tt of 0.3). Further, as the optimum area D is smaller than the optimum area C, the difference in the supercharged air density ρ between the center and boundary of the area can be decreased even more.

While the invention has been described by reference to specific embodiments chosen for purposes of illustration, it should be apparent that numerous modifications could be made thereto, by those skilled in the art, without departing from the basic concept and scope of the invention.

1. An intercooler arranged downstream of a supercharger in an intake air flow to compress and cool the intake air of an internal combustion engine by exchanging heat between the intake air and a cooling fluid, comprising:
a plurality of tubes having an internal path of the intake air; and
a plurality of inner fins arranged in the tubes in such a manner as to divide the flow path in each of the tubes into a plurality of thin flow paths to promote the heat exchange between the intake air and the cooling fluid;
wherein each of the inner fins is a straight fin with walls dividing the flow path into the thin flow paths and extending linearly in the direction of the intake air flow,
wherein the supercharged air flow rate is not less than 1200 kg/hr,
wherein the tube is formed of a selected one of copper and a copper alloy having the plate thickness of 0.1 to 0.5 mm, and
wherein, assuming the interval between adjacent ones of the tubes along the stacking direction as a tube pitch Tp, the height of the tube in the stacking direction as a tube height Th, the tube pitch Tp as x (in mm) and the tube height Th as y (in mm), then the relation between x and y satisfies the following four equations:
3≦y≦−0.0108x²+0.778x−1.86(7.3≦x≦8.6) (Equation 1)
0.0107x²−0.138x+3.45≦y≦−0.0108x²+0.778x−1.86(8.6≦x≦21.6) (Equation 2)
0.0107x²−0.138x+3.45≦y≦10 (21.6≦x≦26.3) (Equation 3)
0.0107x²−0.138x+3.45≦y≦−0.667x+27.5(26.3≦x≦27.8) (Equation 4)

2. An intercooler according to claim 1 wherein, assuming the tube pitch Tp as x (in mm) and the tube height Th as y (in mm), the relation between x and y satisfies the following five equations:
4≦y≦−0.0165x²+0.966x−3.49(9.5≦x≦12.6) (Equation 5)
−0.00120x²+0.250x+1.00≦y≦−0.0165x²+0.966x−3.49(12.6≦x≦22.3) (Equation 6)
0.0732x²−3.04x+37.4≦y≦−0.0165x²+0.966x−3.49(22.3≦x≦22.8) (Equation 7)
0.0732x²−3.04x+37.4≦y≦10(22.8≦x≦25.5) (Equation 8)
0.0732x²−3.04x+37.4≦y≦−0.667x+27.0(25.5≦x≦27.9) (Equation 9)

3. An intercooler according to claim 1 wherein, assuming the tube pitch Tp as x (in mm) and the tube height Th as y (in mm), the relation between x and y satisfies the following three equations:
4≦y≦−0.0198x²+0.995x−3.34(9≦x≦13.7) (Equation 10)
0.0265x²−0.660x+8.15≦y≦−0.0198x²+0.995x−3.34(13.7≦x<22.5) (Equation 11)
0.0265x²−0.660x+8.15≦y≦−0.556x+21.5(22.5≦x≦24.3) (Equation 12)

4. An intercooler according to claim 1 wherein, assuming the tube pitch Tp as x (in mm) and the tube height Th as y (in mm), the relation between x and y satisfies the following three equations:
5≦y≦−0.0380x²+1.58x−8.13(11.5≦x≦15.9) (Equation 13)
0.0507x²−1.57x+17.1≦y≦−0.0380x²+1.58x−8.13(15.9≦x≦17.7) (Equation 14)
0.0507x²−1.57x+17.1≦y≦8(17.7≦x≦23.2) (Equation 15)

5. An intercooler according to claim 1, wherein the tubes are formed of selected one of stainless steel and steel and have the plate thickness of 0.07 to 0.5 mm.

6. An intercooler according to claim 1, wherein de/(S/Swa) is 0.2 to 7.5, where S is the sectional area in one tube, Swa the total area of the thin flow paths in one tube, and de (in mm) is the equivalent circle diameter of one thin flow path.

7. An intercooler according to claim 6, wherein de/(S/Swa) is 0.3 to 4.5.

8. An intercooler according to claim 6, wherein de/(S/Swa) is 0.5 to 3.5.

9. An intercooler according to claim 1, wherein the inner fins are offset fins with walls arranged in a staggered fashion along the direction of an intake air flow to divide the flow path into a plurality of the thin flow paths.

10. An intercooler according to claim 9, wherein de/(S/Swa) is 0.4 to 9.5, where S is the sectional area in one tube, Swa the total area of the thin flow paths in one tube, and de the equivalent circle diameter (in mm) of one thin flow path.

11. An intercooler according to claim 10, wherein de/(S/Swa) is 0.6 to 7,2.

12. An intercooler according to claim 10, wherein de/(S/Swa) is 0.8 to 6.2.
